(19) United States
(12) Patent Application Publication
(10) Pub. No.: US 2003/0044229 A1
(43) Pub. Date: Mar. 6, 2003

(54) Fastener system

(76) Inventor: Norbert Kott, Fort Langley (CA)

Correspondence Address: C. A. ROWLEY, P. O. BOX 59, 51 RIVERSIDE PARKWAY, FRANKFORD, ON, K0K 2C0, CA

(21) Appl. No.: 09/946,725

(22) Filed: Sep. 6, 2001

(51) Int. Cl. F16B 1/00; B25G 3/28; F16G 11/00

(52) U.S. Cl. 403/282

(57) ABSTRACT

A fastener includes a male fastener and a cooperating female fastener where the male fastener element is operated by at least one elongated deformable the wall of a compartment and an ed wall with which the male fastener is integrally connected and from which the male fastener forms a projection. For example the elongated deformable wall(s) of the compartment may be deformed by pressure in the compartment so that deformation of the deformable wall deforms the end wall and moves a free end of the projection remote from the wall of the compartment between a latching position and an unlatching position when the deformable wall is deformed.

### FIELD OF THE INVENTION

The present invention relates to a male, female fastening system providing an improved operating system for latching and unlatching eh fastener

### BACKGROUND TO THE INVENTION

U.S. Pat. No. 5,102,253 issued Apr. 7, 1992 to Pugltest-Conti et al. discloses a snap fit coupling or fastening system wherein fastener elements are provided on the sides of deformable compartments or at the ends of deformable arms and means are provided to directly bend the arm or sidewall on which the fastener element is mounted.

The pressure at the connection formed by the male and female members of U.S. Pat. No. 5,102,253 is limited to the lowest vacuum, which can be created and thus requires the use of very flexible materials and/or very large assemblies. The hydraulic actuation system of this patent only assists in the dismantling of the connection but can't be used for the engaging of the fastener system. Furthermore the system is prone to leakage at the interface between the male and the female member of the connection. Another concern with the system of U.S. Pat. No. 5,102,253 is that it applies the actuation force to both the male and the female parts of the connection thereby deforming both. The patent is also limited to the use of snap fit design due to its limited actuation force.

### BRIEF DESCRIPTIONS OF THE INVENTION

It is an object of the invention to provide an improved fastener system.

Broadly the present invention relates to a fastener system comprising a first fastener means and a second fastener means, a male fastener means on said first fastener means and said second fastener means having female fastener for coupling with said male fastener means said first fastener means having a pair of opposed elongated walls and a pair of interconnecting walls interconnecting adjacent ends of said elongated walls to define a compartment, one elongated wall of said pair of elongated walls being deformable by pressure in said compartment, said male fastener means including a projection extending from and integral with said deformable wall and one of said interconnecting end walls so that a free end of said projection remote from said deformable wall moves between a latching position and an unlatching position when said elongated deformable wall is deformed, and means for deforming said first deformable side wall.

Preferably said first fastener means includes an outer housing, said outer housing being spaced from said elongated walls to provide a pair of free spaces one adjacent to said deformable elongated wall and the other adjacent to said second deformable wall into which said deformable elongated wall and said second deformable wall respectively may be deformed.

Preferably the other of said pair of opposed elongated walls is also deformable and wherein said male fastener means includes a second projection extending from and integral with the other of said pair of elongated walls so that a free end of said second projection remote from said other deformable wall moves between a latching position and an unlatching position when said other elongated deformable wall is deformed, deformable wall is deformed,

Preferably said means for deforming acts between said elongated deformable side wall and said second elongated deformable side wall to deform said deformable and said second deformable side walls simultaneously.

Preferably said means for deforming comprises means for applying fluid under pressure into said compartment.

### BRIEF DESCRIPTION OF THE DRAWINGS

Further features, objects and advantageous will be evident from the following detailed description of the invention taken in conjunction with the accompanying drawings in which

FIGS. 1 and 2 are transverse cross sections through a simplified version of the fastener showing the fastener in holding (latching) and released positions respectively.

FIG. 3 is a simplified isometric view of the fastener element on which the male fastener element(s) is (are) formed.

FIG. 4 is a cross section through a fastener employing a single male member and shows the more important dimensions selected to provide a fastener with the desired characteristics such as holding pressure or power showing the fastener holding position.

FIG. 5 is a cross section similar to that of FIG. 4 showing the fastener releasing position.

FIG. 6 is a cross section similar to that of FIG. 4 showing a slightly modified version of the hinge structure of the fastener.

### DETAILED DESCRIPTION OF THE INVENTION

As shown in the drawings the fastener mechanism of the present invention comprises a displaceable male projecting elements that co-cooperates with a female socket 12 into which the projecting male elements are received. Two elements 10 have been shown, as that is the preferred system however only one may be used with a suitable co-operating female element or socket 12. The following description will be directed primarily to the two-element system The co-operating male 10 and female 12 fasteners may be provided with mating undercut latching portions (not illustrated) so that they may be securely locked together.

The key element in this fastener system of the present invention is the hollow module 16 defining a housing in which is contained a central compartment 18 defined on two sides by a pair of opposed elongated deformable walls 14. The walls 14 preferably are substantially symmetrical when in non-deformed condition. Hollow expansion spaces 20 and 22 are formed in the housing 16 one positioned adjacent to and extend in the illustrated arrangement beyond both ends of the chamber 18. These spaces preferably extend beyond the ends of the compartment 18, but that is not essential. However it will be apparent that the length of the elongated wall 14 that can be deformed is dependent on the available space into which it may be deformed thus the length L_{S} and width W_{S} of the spaces 20 and 22 are important to the system. Generally the length Ls will be at least 80% of the length L_{C} (measured perpendicular to the walls 14) of the compartment 18 (i.e. the lengths of its adjacent wall 14) and preferably L_{S} is greater than 100% of the length L_{C} of the compartment 18.

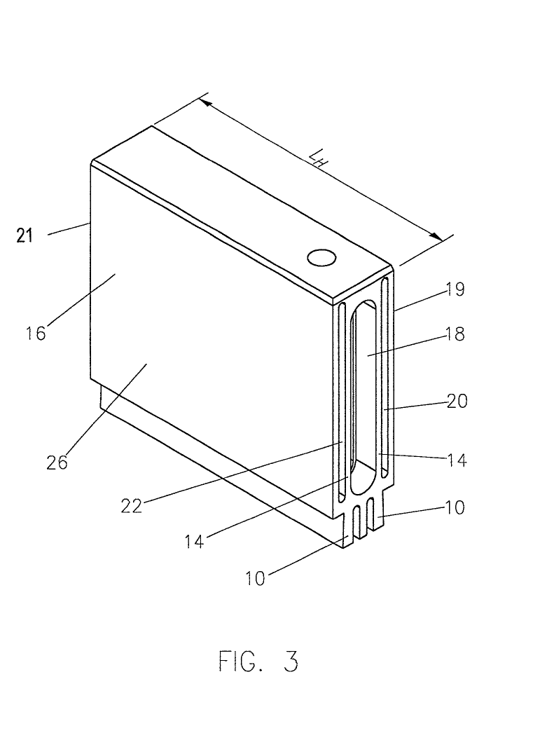

The axial ends of the spaces 20 and 22 and the axial end walls of the compartment 18 are formed by the end walls 15 and 17 of the housing 16. The lateral ends 19 and 21 of the housing 16 may be open (see FIG. 3) so that the compartment 18 and spaces 20 and 22 are open ended. In this case an expanding mechanism such as the bladder 23 (or other means such as expanding mechanical elements) may be positioned in the compartment 18 and inflated or deflated (as schematically illustrated by the two headed arrow 25) to press against the opposed walls 14 and deform them when inflated and permit them to move to relaxed (straight) position when the bladder 23 is deflated. Alternatively the ends 19 and 21 of the compartment 18 may be sealed and means be provided for pumping fluid into and out of he chamber or compartment 18 to deform the walls 14 as above described. Obviously the fluid used may be any suitable fluid such as air or hydraulic fluid.

As above indicated the male members 10 are connected to and form an integral part of the housing 16 and are connected to the walls 14 (via the end wall 15) so that deformation of the walls 14 causes the free ends of the members 10 remote from the walls 14 to move toward each other and release their connection with the female element 12.

It will be noted that the manner in which the walls are deformed is important to having the ends 30 move as required to release the connection i.e. the walls 14 are moved apart more adjacent to the center of the walls (mid length L_{C}) than at the axial ends of the compartment 18 (measured in the length direction depicted by the length L_{C}. The amount of movement of the free end 30 of the male member 10 is obviously dependent on the length L_{M} of the male member 10.

It will be apparent that the compartment 18 and the spaces 20 and 22 may extend substantially the full axial length of the body or housing 16.

It will be apparent that the outer walls 24 and 26 of the body 16 are not deformed when the walls 14 are deformed and thus are able to provide a stable surface for the attachment to one of the parts 28 that the fasteners are to interconnect. In the illustrated arrangement the socket 12 forms part of the second part 31 with which the part 28 is to be connected

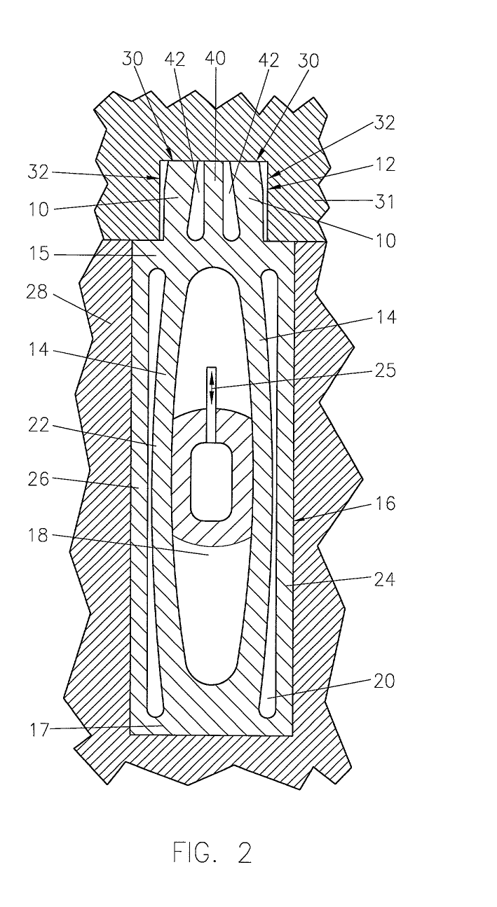

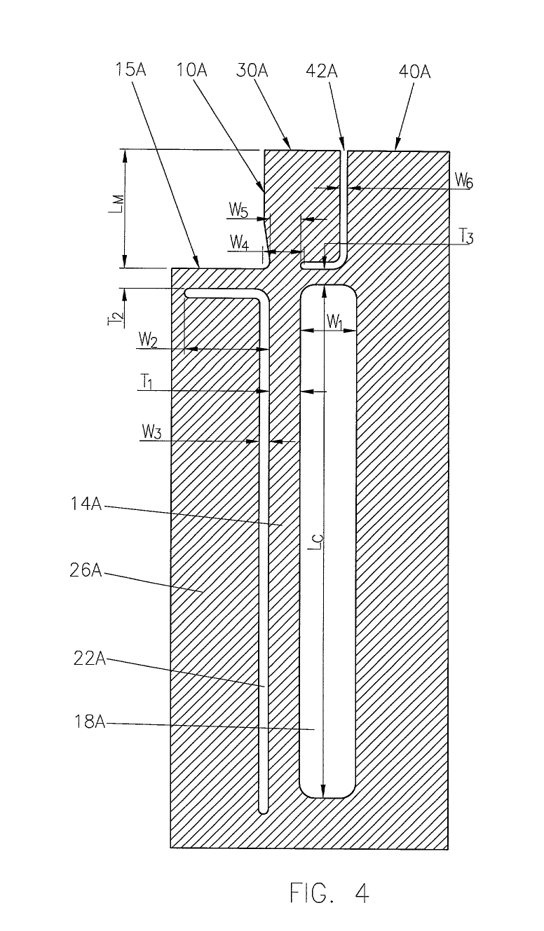

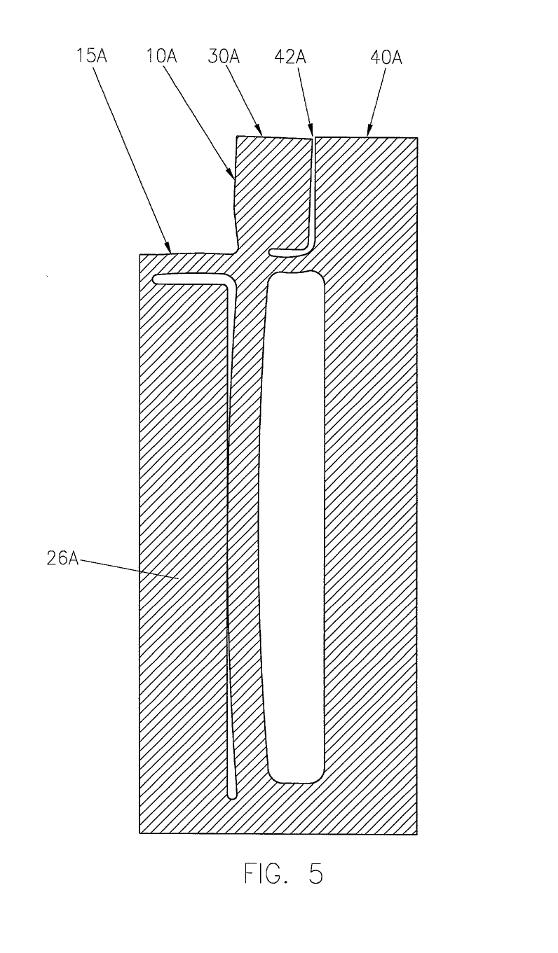

Connected to the body 16 and positioned between the male members 10 is a projection 40 the space 42 between the member or projection 40 may be designed to limit the deflection of the male members 10 when they are moved to unlocked or unlatched position shown in FIG. 2 (and as will be more filly described in connection with FIGS. 4 and 5).

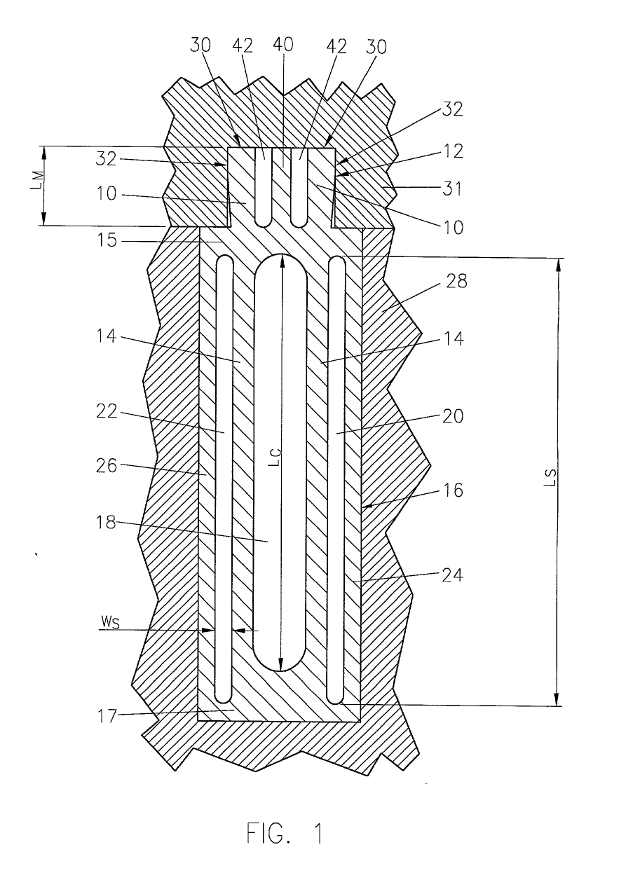

In operation the rest position for the preferred embodiment is illustrated (closed or latched position) is shown in FIG. 1 and the released or unlatched position shown in FIG. 2 where the walls 14 have been expanded into the spaces 20 and 22. In the FIG. 1 position maximum spacing between the ends 30 is obtained to apply pressure against the side walls 32 of the cavity 12 forming the female connector 12. It will be apparent that the side walls 32 and the adjacent sides of the male members 10 may be formed for example with latching undercuts to provide a more positive connection or formed in any suitable manner to provide a connection of the desired characteristics.

In FIGS. 4, 5 and 6 like or similar parts have been designated with like numerals to those used in FIGS. 1 to 3 followed by the letter A.

As shown the cavity 18A in the body 26A has a width W₁ measured perpendicular to the length L_{C} and the space 22A has a similar length and a width W3 and the wall 14A between the cavity 18A and the space 22A has a thickness t₁. It will be apparent that the wall thickness t₁ and length L_{C} (and the material from which the wall 14A is made) are the main factors that determine the force required to deform the wall 14A and unlatch the connector. The dimension W3 defines the amount the wall 14A may be freely deformed.

The amount force (per unit length measured in the direction perpendicular to the paper in FIGS. 4, 5 and 6) that may be applied laterally by the male member 10A in the direction of the arrow 50 is determined primarily by the thickness t₂ of the end wall 15; the thickness t₃ of the end wall of chamber 18A measured between the top of cavity or chamber 18A and the adjacent portion of the space 42A; the width W₁ of the chamber 18A; width W₂ of the unsupported portion of the end wall 15A; the width W₄ of the top of the wall 14A where it intersects the wall 15A and the width W₅ of the root of the male member 10A. These dimensions may be individually selected to determine the strength of the hinge structure of the top or end wall 15A and thus the pressure applied in the direction 50. The dimensions t₁ and L_{C} play a major roll in determining the amount of pressure that must be applied within the cavity 18A to release the fastener. The dimension W₆ may be used to determine the amount of movement the male member 10A may make toward unlatched position (this may also be determined by W₃) and more important may set the maximum deflection of the top of the cavity 18A in the direction parallel to the length L_{C}.

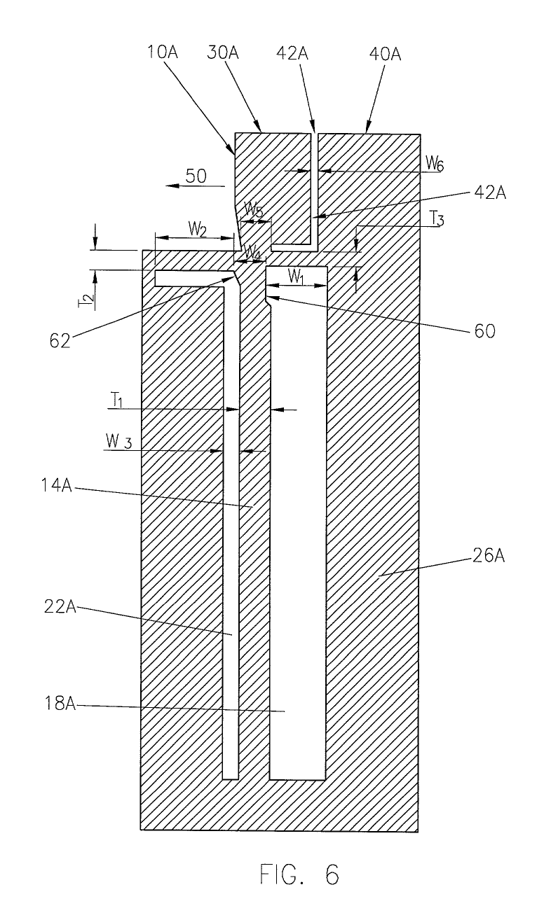

The configuration of the intersection of the walls 14A and 15A may be manipulated to influence the strength of the hinge formed by the wall 15A. For example as shown in FIG. 6 the lay 14A may be undercut as indicated at 60 to in effect extend the effective width W₁ and/or the end of the wall 14A may be flared outward (thickness of wall 14A widened at the intersection with the wall 15A) as indicated at 62 to shorten, in this illustration, the effective width of width W₂.

It will be apparent that the outer surfaces of the male members 10 may be of any suitable shape, for example they may be formed as segments of a circle that when in relaxed condition form an interference fit with a correspondingly shaped mating socket.

Having described the invention modifications will be evident to those skilled in the art without departing from the spirit of the invention as defined in the appended claims.

1. A fastener system comprising a first fastener means and a second fastener means, a male fastener means on said first fastener means and said second fastener means having a female fastener for coupling with said male fastener means, said first fastener means having a pair of opposed elongated walls and a pair of interconnecting end walls interconnecting adjacent ends of said elongated walls to define a compartment, one elongated wall of said pair of elongated walls being a deformable elongated wall deformable by pressure in said compartment, said male fastener means including a projection extending from and integral with said deformable wall and one of said interconnecting end walls so that a free end of said projection remote from said deformable wall moves between a latching position and an unlatching position when said elongated deformable wall is deformed, and means for deforming said first deformable side wall.

2. A fastener system as defined in claim 1 wherein said first fastener means includes an outer housing, said outer housing being spaced from said deformable elongated wall to provide a free space adjacent to said deformable elongated wall into which said deformable elongated wall may be deformed and said one interconnecting end wall interconnecting said housing with said one elongated deformable wall.

3. A fastener system as defined in claim 1 wherein the other of said pair of opposed elongated walls is also deformable and provides a second elongated deformable wall and wherein said male fastener means includes a second projection extending from and integral with said second deformable elongated wall so that a free end of said second projection remote from said second deformable wall moves between a latching position and an unlatching position when said second elongated deformable wall is deformed, and wherein said means for deforming said first deformable side wall acts between said first and said second deformable side was to deform said first and said second deformable side walls simultaneously.

4. A fastener system as defined in claim 3 wherein said first fastener means includes an outer housing, said outer housing being spaced from said elongated walls to provide a pair of free spaces one adjacent to said one deformable elongated wall and the other adjacent to said second elongated deformable wall into which said one deformable elongated wall and said second deformable wall respectively may be deformed.

5. A fastener system as defined in claim 3 wherein said means for deforming acts between said elongated deformable side wall and said second elongated deformable side wall to deform said deformable and said second deformable side walls simultaneously.

6. A fastener system as defined in claim 4 wherein said means for deforming acts between said elongated deformable side wall and said second elongated deformable side wall to deform said deformable and said second deformable side walls simultaneously.

7. A fastener system as defined in claim 1 wherein said means for deforming comprises means for applying fluid under pressure into said compartment.

8. A fastener system as defined in claim 2 wherein said means for deforming comprises means for applying fluid under pressure into said compartment.

9. A fastener system as defined in claim 3 wherein said means for deforming comprises means for applying fluid under pressure into said compartment.

10. A fastener system as defined in claim 4 wherein said means for deforming comprises means for applying fluid under pressure into said compartment.
